(19) United States
(12) Patent Application Publication
(10) Pub. No.: US 2020/0319349 A1
(43) Pub. Date: Oct. 8, 2020

(54) POSITION DETECTION SYSTEM, POSITION DETECTION DEVICE, AND POSITION DETECTION METHOD

(71) Applicant: FUJITSU LIMITED, Kawasaki-shi (JP)

(72) Inventor: Jun-ichi NAGATA, Kawasaki (JP)

(73) Assignee: FUJITSU LIMITED, Kawasaki-shi (JP)

(21) Appl. No.: 16/833,086

(22) Filed: Mar. 27, 2020

(30) Foreign Application Priority Data
Apr. 2, 2019 (JP) 2019-070625

(51) Int. Cl. G01S 19/29; G01S 19/34; G01S 19/05

(52) U.S. Cl. CPC G01S 19/29; G01S 19/05; G01S 19/34

(57) ABSTRACT

An information control method executed by a computer, includes obtaining, from a storage device storing measurement data obtained when a sensor terminal receives a satellite signal from a GNSS satellite as a snapshot, first measurement data at a first time and second measurement data at a second time in each of which the number of acquired satellites is less than five and in which the total number of acquired satellites is greater than or equal to five; combining the first measurement data and the second measurement data together using a time difference between the first time and the second time such that the number of acquired satellites is greater than or equal to five; and computing a position of the sensor terminal.

### CROSS-REFERENCE TO RELATED APPLICATION

This application is based upon and claims the benefit of priority of the prior Japanese Patent Application No. 2019-70625, filed on Apr. 2, 2019, the entire contents of which are incorporated herein by reference.

### FIELD

The embodiments discussed herein are related to a position detection system, a position detection device, and a position detection method.

### BACKGROUND

Positioning techniques using satellite signals from artificial satellites are disclosed (refer to, for example, Japanese Laid-open Patent Publication No. 2017-32426 and Japanese Laid-open Patent Publication No. 2015-68767). Examples of the positioning technique using satellite signals include snapshot positioning. In the snapshot positioning, satellite signals are received in a short period of about several tens of milliseconds (ms) to 100 ms, IQ sample signals are generated, and calculations for positioning are performed. Satellite orbit information used other than the IQ samples is acquired from a computing device (server) of the National Aeronautics and Space Administration (NASA) or the like via a network.

### SUMMARY

According to an aspect of the embodiments, A position detection system includes a sensor terminal that includes a first memory and a first processor coupled to the first memory; and a computing device that includes a second memory and a second processor coupled to the second memory, wherein the first processor is configured to receive a satellite signal from a GNSS satellite as a snapshot, and the second processor is configured to: obtain, from a storage device storing measurement data obtained when the sensor terminal performs snapshot reception, first measurement data at a first time and second measurement data at a second time in each of which the number of acquired satellites is less than five and in which the total number of acquired satellites is greater than or equal to five, combine the first measurement data and the second measurement data together using a time difference between the first time and the second time such that the number of acquired satellites is greater than or equal to five, and compute a position of the sensor terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating snapshot reception;

FIGS. 2A and 2B are diagrams illustrating acquisition of satellites;

FIG. 3 is a diagram illustrating computations for snapshot positioning;

FIG. 4A is a block diagram illustrating an overall configuration of a position detection system according to an embodiment, FIG. 4B is a block diagram illustrating a relay device, and FIG. 4C is a block diagram illustrating a computing device;

FIG. 5 is a diagram illustrating a flowchart that represents a process executed by a computing device;

FIG. 6 is a diagram illustrating analysis in a data combination mode;

FIG. 7 is a diagram illustrating computations for snapshot positioning; and

FIGS. 8A and 8B are diagrams for organizing position detection according to an embodiment.

### DESCRIPTION OF EMBODIMENTS

In a snapshot positioning technique, some of the global navigation satellite system (GNSS) satellites easily become invisible to a sensor terminal in an environment where there are many shields between the GNSS satellites and the sensor terminal. Thus, if the number of acquired satellite signals is less than the number desired for calculations, the case where it is not possible to perform calculations for positioning occurs. In view of the above, it is desirable to provide a position detection system, a position detection device, and a position detection method that may detect the position of a sensor terminal based on measurement data of an insufficient number of acquired GNSS satellites.

For example, a sensor terminal for receiving signals of Global Positioning System (GPS), which is a type of GNSS, consumes a large amount of power and therefore carries a large battery. This configuration hinders miniaturization and weight reduction of the sensor terminal. If a small battery is used, the operable time of the sensor terminal is short. This configuration leads to an increase in maintenance costs due to battery replacement. The consumed power of a sensor terminal for receiving GPS signals is large because the data rate of a satellite signal is as low as 50 bps and the operating time for the sensor terminal to receive the satellite signal is as long as 30 seconds to 12.5 minutes.

To solve this problem, a technique called snapshot positioning has been developed. In this technique, a sensor terminal operates only for a short time of about several tens of milliseconds, and a code phase and a Doppler frequency obtained during this time are used to perform computations for positioning. A method in which an ephemeris (satellite orbit data) and the like desired for computations for positioning are acquired over a network and the computations for positioning are performed in the cloud has been proposed.

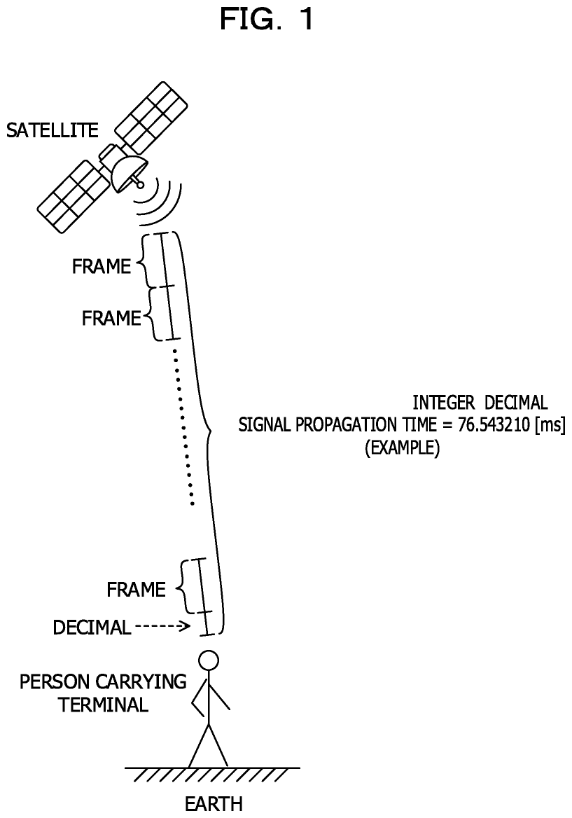

However, as illustrated in FIG. 1, in the snapshot reception, it is difficult to obtain information of the integer component of a signal propagation time in milliseconds taken from a GNSS satellite to a sensor terminal. If this integer component is not obtained, it is difficult to perform computations for positioning of the sensor terminal. To address this, the Doppler frequency of received signals is used to narrow down potential positions to an approximate position. Furthermore, the position of a relay device (receiving station) that receives a code phase and a Doppler frequency from the sensor terminal is used. Thereby, the position of the sensor terminal may be accurately measured.

However, in an environment, such as urban areas, where there are many shields between GNSS satellites and a sensor terminal, some of the GNSS satellites easily become invisible to the sensor terminal. If the number of acquired GNSS satellites is less than the number desired for calculations for positioning, the case where it is not possible to perform calculations for positioning occurs. When some of the satellites are invisible continuously since the start-up of the sensor terminal, it is difficult to interpolate the positions at an intermediate time point from the positioning results before and after the time point.

For example, in Cloud-Offloaded GPS (CO-GPS) proposed by Microsoft Corporation, in order to perform calculations for positioning only from a code phase and a Doppler frequency, a new variable called “coarse time error” is introduced into computations for positioning. In this scheme, the total number of desired variables, which also include the x-, y-, and z-coordinates of the sensor terminal and a time correction, is five. It is therefore desired that five or more GNSS satellites be acquired in order to allow positioning to be achieved. However, in an area with many obstacles, a low elevation GNSS satellite is sometimes unable to be acquired because of a shield or the like.

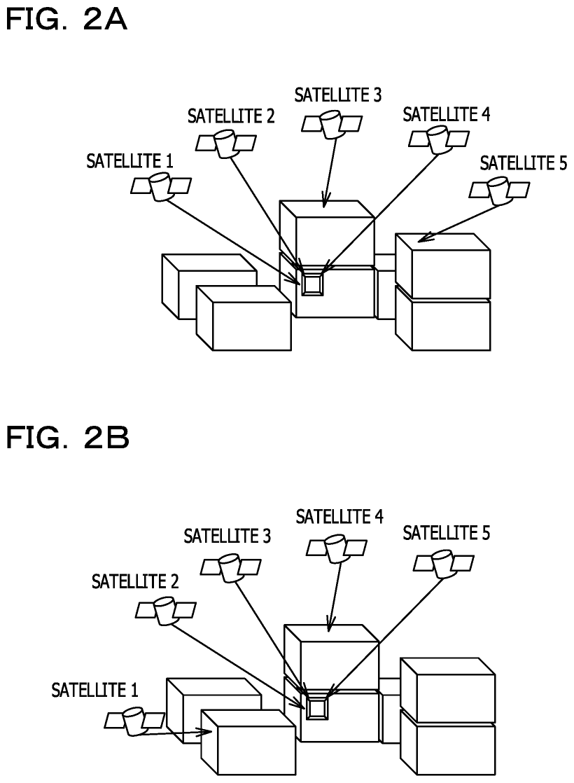

For example, as illustrated in FIG. 2A, in container management or the like in a harbor, there are some cases where containers around a sensor terminal serve as shields such that positioning fails due to a shortage in the number of acquired satellites. In the example in FIG. 2A, at a first time, GNSS satellites 3 and 5 are unable to be acquired. For example, in a condition where shields are clustered together, even when the satellite constellation varies over time, another GNSS satellite may be shielded. In this case, with only the measurement data at a single time, eventually, a desired number of acquired satellites is not secured for positioning. Thus, the situation continues where the positioning is difficult to achieve. For example, as illustrated in FIG. 2B, at a second time, although the GNSS satellites 3 and 5 may be acquired, GNSS satellites 1 and 4 are unable to be acquired. In such a manner, it is difficult to acquire all of the GNSS satellites 1 to 5 at a simultaneous time (single time).

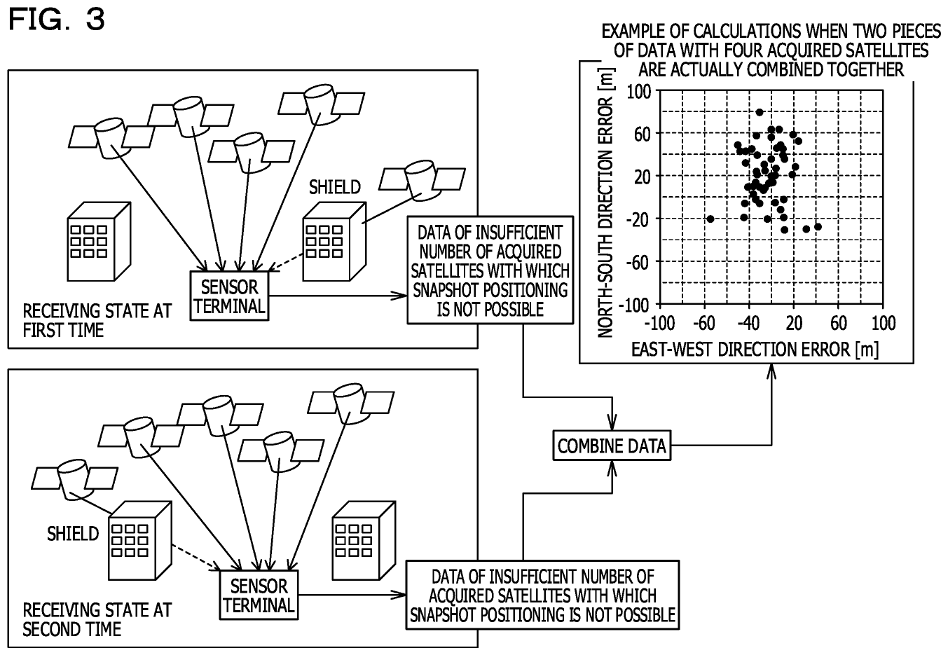

To address this, as illustrated in FIG. 3, in computations for snapshot positioning, measurement data with less than five acquired satellites from which no position solution is obtained is combined with another measurement data with an insufficient number of acquired satellites, taking into account a difference in the time at which measurement is performed, such that the number of independent satellites is five or more. In such a way, a position solution may be obtained based on measurement data in which the number of satellites acquired at a single time is less than five.

Hereinafter, embodiments will be described with reference to the drawings.

### First Embodiment

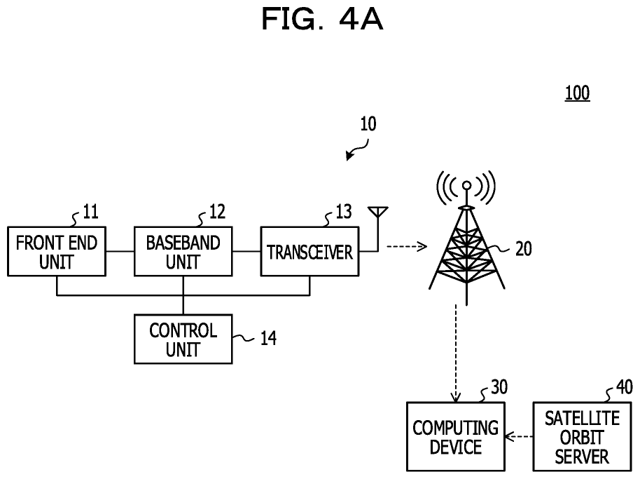

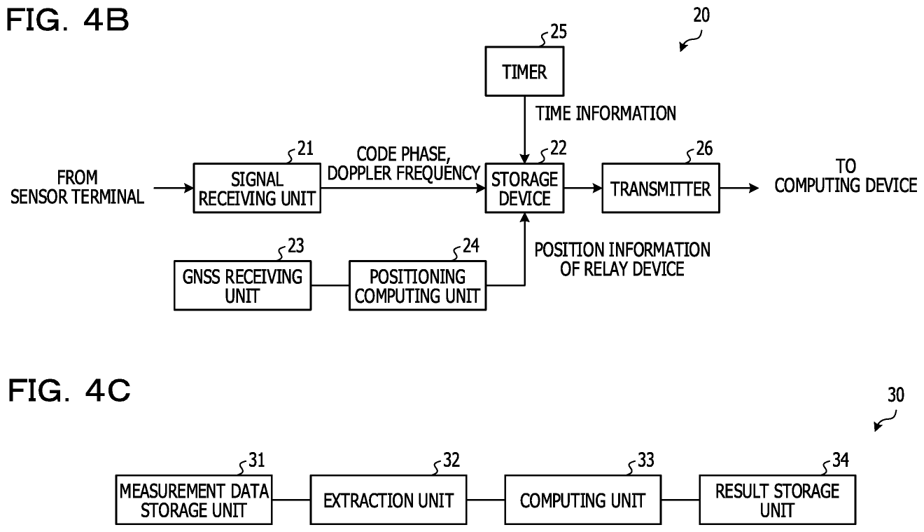

FIG. 4A is a block diagram illustrating an overall configuration of a position detection system 100 according to a first embodiment. As illustrated in FIG. 4A, the position detection system 100 has a structure in which a sensor terminal 10, a relay device 20, a computing device 30, a satellite orbit server 40, and the like are communicably coupled in a wireless or wired manner. The sensor terminal 10 is a GNSS sensor terminal including a front end unit 11, a baseband unit 12, a transceiver 13, a control unit 14, and so on. The sensor terminal 10 transmits a code phase, a Doppler frequency, and the like in a wireless manner to the relay device 20. The relay device 20 transmits a code phase, a Doppler frequency, time information, a base station position, received signal strength indicator (RSSI) information, and the like in a wireless or wired manner to the computing device 30. The computing device 30 performs computations for positioning from information received from the relay device 20 and satellite orbit information received from the satellite orbit server 40 over a network of NASA or the like and calculates the position (latitude and longitude) of the sensor terminal 10.

The front end unit 11, which functions as an analog front end, receives GNSS satellite signals from GNSS satellites as snapshots in a predetermined period (sampling period) and, for each of the acquired satellites, converts the received GNSS satellite signals into digital IQ samples. The IQ sample is a signal obtained by down-converting a satellite signal from a radio frequency (RF) band to an intermediate frequency (IF) band, causing the down-converted signal to pass through a band limiting filter, and then applying analog-to-digital conversion to the filtered signal. The signal is called an IQ sample because it is down-converted with two quadrature phases of I and Q.

The baseband unit 12 calculates raw data from the IQ samples received from the front end unit 11 by baseband processing and outputs the calculated raw data. The raw data is a code phase and a Doppler frequency that are obtained by performing baseband processing (satellite acquisition processing) on IQ samples obtained from satellite signals. These two types of values are calculated as many times as the number of GNSS satellites acquired. The code phase represents the decimal component of a signal propagation delay in milliseconds from a GNSS satellite to the sensor terminal 10. The transceiver 13 wirelessly transmits, for each acquired satellite, the raw data output from the baseband unit 12 as snapshot GNSS signals.

FIG. 4B is a block diagram illustrating the relay device 20. The relay device 20 is a low-power wide-area (LPWA) base station, access point, or gateway. As illustrated in FIG. 4B, the relay device 20 includes a signal receiving unit 21, a storage device 22, a GNSS receiving unit 23, a positioning computing unit 24, a timer 25, a transmitter 26, and so on. A plurality of relay devices 20 are provided. The relay devices 20 are disposed at different locations.

The signal receiving unit 21 receives raw data transmitted from the sensor terminal 10. The signal receiving unit 21 extracts, for each acquired satellite, the code phase and the Doppler frequency included in the raw data and causes the storage device 22 to store the code phase and the Doppler frequency. The GNSS receiving unit 23 receives GNSS satellite signals from GNSS satellites. In this case, the GNSS receiving unit 23 does not perform snapshot reception but receives both the integer value and the decimal value of the signal propagation time. The positioning computing unit 24 uses the GNSS satellite signals received by the GNSS receiving unit 23 to calculate the position of the relay device 20 and causes the storage device 22 to store the calculated position. The timer 25 causes the storage device 22 to store time information (such as the current time). The storage device 22 stores the code phase and the Doppler frequency received from the signal receiving unit 21 and the position of the relay device 20 received from the positioning computing unit 24 in association with the time information received from the timer 25. For example, the storage device 22 adds the position of the relay device 20 and a time to the raw data. The transmitter 26 transmits information stored in the storage device 22 as measurement data for each acquired satellite in a sampling period of the sensor terminal 10.

FIG. 4C is a block diagram illustrating the computing device 30. As illustrated in FIG. 4C, the computing device 30 includes a measurement data storage unit 31, an extraction unit 32, a computing unit 33, a result storage unit 34, and so on. The measurement data storage unit 31 stores measurement data received from the relay device 20 for each time added by the relay device 20. Accordingly, the measurement data storage unit 31 stores the measurement data in association with each time of the sampling period of the sensor terminal 10. The extraction unit 32 extracts measurement data to be used for computations for positioning from the measurement data storage unit 31. The computing unit 33 performs computations for positioning using the measurement data extracted by the extraction unit 32. The result storage unit 34 stores results of computations for positioning performed by the computing unit 33.

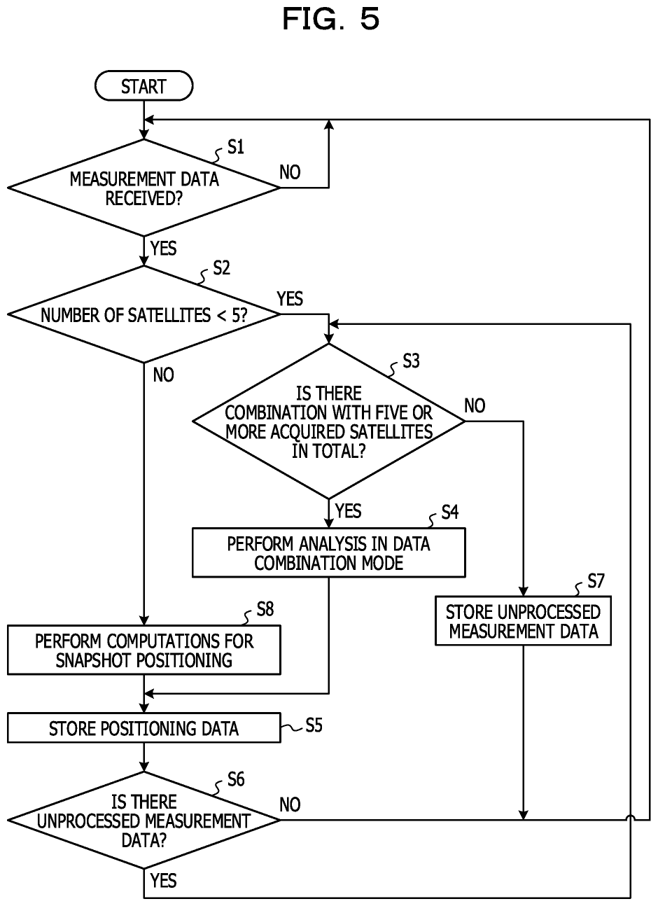

FIG. 5 is a diagram illustrating a flowchart that represents a process executed by the computing device 30. As illustrated in FIG. 5, the extraction unit 32 determines whether the extraction unit 32 has received measurement data of the sensor terminal 10 from the relay device 20 (step S1). If “No” is determined in step S1, the extraction unit 32 executes again step S1. If “Yes” is determined in step S1, the extraction unit 32 determines whether the number of acquired satellites according to the measurement data received in step S1 is less than five (step S2).

If “Yes” is determined in step S2, the extraction unit 32 determines whether, among stored measurement data, there is a combination of measurement data in which the total number of acquired satellites is five or more (step S3). It is determined whether there is a combination of measurement data in which some of the acquired GNSS satellites overlap between two pieces of measurement data obtained at times different from each other and the total number of GNSS satellites different from each other is greater than or equal to five. For example, if there is a combination of measurement data with the acquired GNSS satellites of four types A to D and measurement data with the acquired GNSS satellites of four types B to E, “Yes” is determined in step S3.

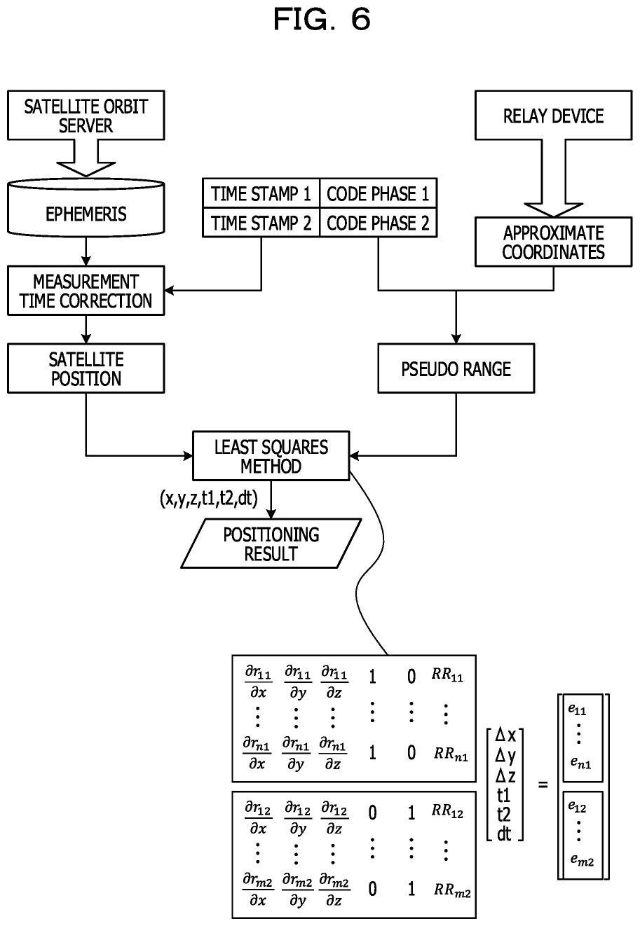

If “Yes” is determined in step S3, the computing unit 33 performs analysis in a data combination mode (step S4). FIG. 6 is a diagram illustrating analysis in the data combination mode. The extraction unit 32 extracts, from the measurement data storage unit 31, first measurement data and second measurement data of the combination for which “Yes” is determined in step S3. The first measurement data is measurement data of a time stamp 1. The second measurement data is measurement data of a time stamp 2. The time stamp is a time assigned by the relay device 20. In each measurement data, raw data for each of acquired satellites is included.

The computing unit 33 obtains satellite orbit information (ephemerides) of the acquired satellites of the first measurement data and of the acquired satellites of the second measurement data from the satellite orbit server 40. Using the satellite orbit information, the computing unit 33 calculates the coordinates of each GNSS satellite (satellite coordinates 1) at the time stamp 1 and the coordinates of each GNSS satellite (satellite coordinates 2) at the time stamp 2. Next, the computing unit 33 calculates the distance (pseudorange 1) between each GNSS satellite and the sensor terminal 10 from the code phase of the first measurement data. In this case, the computing unit 33 may exclude a shadow location by using the position information of the relay device 20. At the time stamp 1, the difference between the distance from an nth GNSS satellite according to the first measurement data to the sensor terminal 10 and the pseudorange is denoted by eₙ₁ (n<5). At the time stamp 2, the difference between the distance from an mth GNSS satellite according to the second measurement data to the sensor terminal 10 and the pseudorange is denoted by eₘ₂ (m<5).

Next, taking into account a difference in the time at which measurement is performed, the computing unit 33 combines data with another measurement data with an insufficient number of acquired satellites, such that the number of independent satellites is greater than or equal to five. For example, the computing unit 33 calculates the coordinates of the sensor terminal 10 and a time variable by using the least squares method such that the difference between the true distance from each GNSS satellite to the sensor terminal 10 and the pseudorange from each GNSS satellite to the sensor terminal 10 is minimized. For example, the computing unit 33 uses a matrix equation illustrated in FIG. 6.

In the equation, rₙ₁ denotes the calculated distance between the nth GNSS satellite and the sensor terminal 10 at the time stamp 1. The partial derivative term of rₙ₁ with respect to x represents the rate of change of the calculated distance to the nth GNSS satellite when x of the coordinates of the sensor terminal 10 at the time stamp 1 changes. The partial derivative term of rₙ₁ with respect to y represents the rate of change of the calculated distance to the nth GNSS satellite when y of the coordinates of the sensor terminal 10 at the time stamp 1 changes. The partial derivative term of rₙ₁ with respect to z represents the rate of change of the calculated distance to the nth GNSS satellite when z of the coordinates of the sensor terminal 10 at the time stamp 1 changes.

In the equation, rₘ₂ denotes the true distance between the mth GNSS satellite and the sensor terminal 10 at the time stamp 2. The partial derivative term of rₘ₂ with respect to x represents the rate of change of the calculated distance to the mth GNSS satellite when x of the coordinates of the sensor terminal 10 at the time stamp 2 changes. The partial derivative term of rₘ₂ with respect to y represents the rate of change of the calculated distance to the mth GNSS satellite when y of the coordinates of the sensor terminal 10 at the time stamp 2 changes. The partial derivative term of rₘ₂ with respect to z represents the rate of change of the calculated distance to the mth GNSS satellite when z of the coordinates of the sensor terminal 10 at the time stamp 2 changes.

RRₙ₁ denotes the range rate for the nth GNSS satellite at the time stamp 1 and represents a relative distance movement per unit time (relative distance change rate) between the satellite and the sensor terminal 10. For example, RRₙ₁ is a correction term of the velocity of the nth GNSS satellite at the time stamp 1. RRₘ₂ denotes a range rate for the mth GNSS satellite at the time stamp 2. For example, RRₘ₂ is a correction term of the velocity of the mth GNSS satellite at the time stamp 2.

In the equation, Δx, Δy, and Δz are respectively position correction terms of the sensor terminal 10 at the x-, y-, and z-coordinates. Also, t1 and t2 correspond to time variables for compensating for time lags in measurement respectively at the time stamp 1 and the time stamp 2. Also, dt denotes a time variable and corresponds to a coarse time error at the time stamp 1 and the time stamp 2.

In the matrix equation in FIG. 6, unknown variables are Δx, Δy, Δz, t1, t2, and dt. By using the least squares method, the computing unit 33 calculates Δx, Δy, Δz, t1, t2, and dt with which the difference between the right side and the left side of the equation in FIG. 6 is minimized. The computing unit 33 calculates the x-, y-, and z-coordinates of the sensor terminal 10 using the calculated Δx, Δy, and Δz. This corresponds to calculating a sensor terminal position that satisfies |(coordinates of each satellite)|(position of sensor terminal)|+t+α×dt+correction term=(pseudorange). The result storage unit 34 stores the obtained result as a positioning result (step S5).

Next, the extraction unit 32 determines whether there is unprocessed measurement data received from the relay device 20 (step S6). If “Yes” is determined in step S6, step S2 is executed again. If “No” is determined in step S6, step S1 is executed again. If “No” is determined in step S3, the measurement data storage unit 31 stores unprocessed measurement data (step S7). After that, step S1 is executed again.

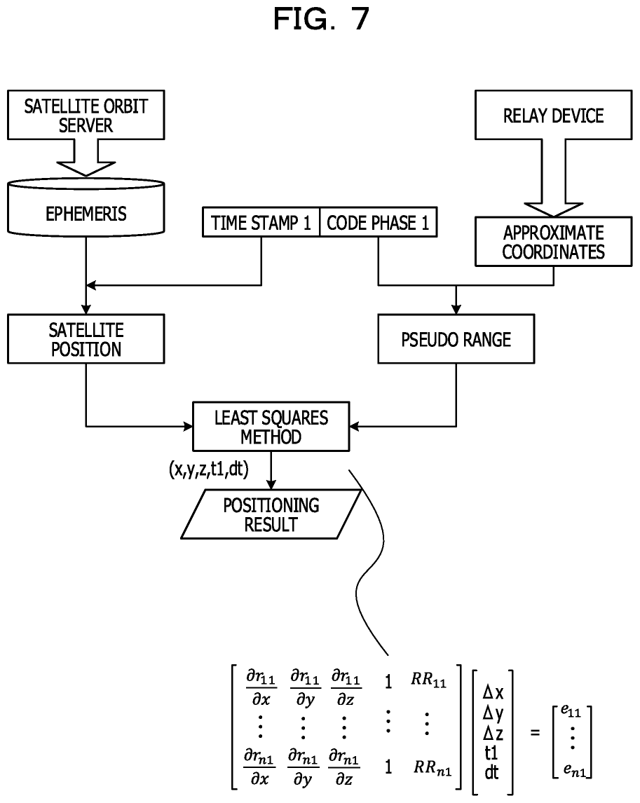

If “No” is determined in step S2, the computing unit 33 performs computations for snapshot positioning (step S8). In this case, the computing unit 33 uses a matrix equation illustrated in FIG. 7. The differences from the matrix equation in FIG. 6 are that the portion for the measurement data at the time stamp 2 is removed and that n denotes an integer greater than or equal to five. After execution of step S8, step S5 is executed.

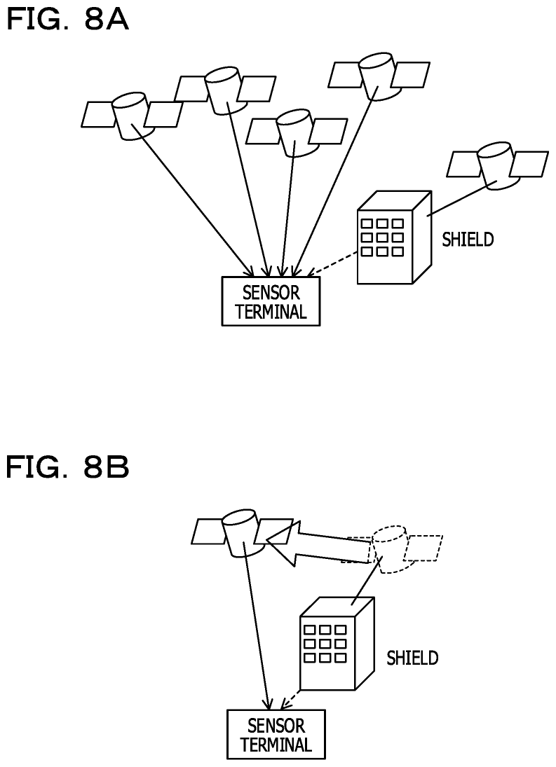

FIGS. 8A and 8B are diagrams for organizing position detection according to the present embodiment. As illustrated in FIG. 8A, among GNSS satellites, satellites, such as GPS satellites, that are not in a geostationary orbit appear to move relative to the ground coordinates. Accordingly, part of the satellites is shielded by an obstacle depending on the time of day. However, over time, the satellite moves and thus the shield is removed as illustrated in FIG. 8B. Applying a difference in the time at which data is measured, as a correction amount, to the time of satellite orbit calculation enables measurement data at another time point to be used in a similar manner. Thereby, data may be combined together, enabling computations for positioning. For example, even for the case where only four satellites are able to be observed at each of time points and computations for positioning are not applicable to each of the respective pieces of data at the time points, when five independent GNSS satellites are included in the entirety of the pieces of data, computations for positioning equivalent to those of data with five acquired satellites may be performed by combining the pieces of data together.

According to the present embodiment, measurement data obtained when the sensor terminal 10 receives satellite signals from GNSS satellites as snapshots is stored in the measurement data storage unit 31. The extraction unit 32 extracts, from the measurement data storage unit 31, first measurement data at a first time and second measurement data at a second time in each of which the number of acquired satellites is less than five and in which the total number of acquired satellites is greater than or equal to five. The computing unit 33 obtains the first measurement data and the second measurement data, combines the first measurement data and the second measurement data together using a time difference between the first time and the second time such that the number of acquired satellites is greater than or equal to five, and computes the position of the sensor terminal 10. According to this configuration, even when the number of acquired GNSS satellites is insufficient, the position of a sensor terminal may be detected.

In the example described above, the pseudorange between each GNSS satellite and the sensor terminal 10 may be calculated using an RSSI. For example, the signal receiving unit 21 receives raw data transmitted from the sensor terminal 10 and calculates an RSSI. The signal receiving unit 21 extracts a code phase and a Doppler frequency included in the raw data and causes the storage device 22 to store the code phase and the Doppler frequency in association with the RSSI. The storage device 22 stores the RSSI, the code phase, and the Doppler frequency received from the signal receiving unit 21 and the position of the relay device 20 received from the positioning computing unit 24 in association with the time information received from the timer 25. For example, the storage device 22 adds the RSSI, the position of the relay device 20, and the time information to the raw data. The transmitter 26 transmits the information stored in the storage device 22. The computing unit 33 narrows down potential positions of the sensor terminal 10 by performing trilateration using the RSSIs of three or more relay devices 20. This enables the computing unit 33 to calculate the initial position of the sensor terminal 10. The pseudorange between each GNSS satellite and the sensor terminal 10 may be calculated by using this initial value.

In the example described above, the sensor terminal 10 functions as an example of a sensor terminal that receives satellite signals from GNSS satellites as snapshots. The measurement data storage unit 31 functions as an example of a storage unit that stores measurement data obtained when the sensor terminal performs snapshot reception. The computing unit 33 functions as an example of a computing unit that obtains first measurement data at a first time and second measurement data at a second time in each of which the number of acquired satellites is less than five and in which the total number of acquired satellites is greater than or equal to five, combines the first measurement data and the second measurement data together using a time difference between the first time and the second time such that the number of acquired satellites is greater than or equal to five, and computes the position of the sensor terminal.

Although the embodiments of the present disclosure have been described above in detail, the present disclosure is not limited to such particular embodiments and may be variously modified and changed within the scope of the gist of the present disclosure described in claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A position detection system comprising:
a sensor terminal that includes a first memory and a first processor coupled to the first memory; and
a computing device that includes a second memory and a second processor coupled to the second memory, wherein
the first processor is configured to receive a satellite signal from a GNSS satellite as a snapshot, and
the second processor is configured to:
obtain, from a storage device storing measurement data obtained when the sensor terminal receives the snapshot, first measurement data at a first time and second measurement data at a second time in each of which the number of acquired satellites is less than five and in which the total number of acquired satellites is greater than or equal to five,
combine the first measurement data and the second measurement data together using a time difference between the first time and the second time such that the number of acquired satellites is greater than or equal to five, and
compute a position of the sensor terminal.

2. The position detection system according to claim 1, wherein the second processor is configured to
calculate, using satellite coordinates obtained from satellite orbit information of each GNSS satellite and a pseudorange between each GNSS satellite and the sensor terminal calculated from the first measurement data and the second measurement data, a position of the sensor terminal that satisfies |(coordinates of each satellite)−(position of sensor terminal)|+(common bias)+(relative movement distance change rate between each satellite and sensor terminal)×(time variable)+(correction term)=(pseudorange).

3. The position detection system according to claim 2, wherein the second processor is configured to
calculate the position of the sensor terminal by using least squares method.

4. The position detection system according to claim 1, wherein the second processor is configured to
in calculating the pseudorange, use position information of a relay device that has received a snapshot GNSS signal transmitted by the sensor terminal.

5. The position detection system according to claim 1, wherein the second processor is configured to
in calculating the pseudorange, use RSSIs in three or more relay devices that have received a snapshot GNSS signal transmitted by the sensor terminal.

6. A position detection device, comprising:
a memory; and
a processor coupled to the memory and the processor configured to:
obtain, from a storage device storing measurement data obtained when a sensor terminal receives a satellite signal from a GNSS satellite as a snapshot, first measurement data at a first time and second measurement data at a second time in each of which the number of acquired satellites is less than five and in which the total number of acquired satellites is greater than or equal to five,
combine the first measurement data and the second measurement data together using a time difference between the first time and the second time such that the number of acquired satellites is greater than or equal to five, and
compute a position of the sensor terminal.

7. The position detection device according to claim 6, wherein the processor is configured to
calculate, using satellite coordinates obtained from satellite orbit information of each GNSS satellite and a pseudorange between each GNSS satellite and the sensor terminal calculated from the first measurement data and the second measurement data, a position of the sensor terminal that satisfies |(coordinates of each satellite)−(position of sensor terminal)|+(common bias)+(relative movement distance change rate between each satellite and sensor terminal)×(time variable)+(correction term)=(pseudorange).

8. The position detection device according to claim 6, wherein the processor is configured to
calculate the position of the sensor terminal by using least squares method.

9. The position detection device according to claim 6, wherein the processor is configured to
in calculating the pseudorange, use position information of a relay device that has received a snapshot GNSS signal transmitted by the sensor terminal.

10. The position detection device according to claim 6, wherein the processor is configured to
in calculating the pseudorange, use RSSIs in three or more relay devices that have received a snapshot GNSS signal transmitted by the sensor terminal.

11. An information control method executed by a computer, the information control method comprising:
obtaining, from a storage device storing measurement data obtained when a sensor terminal receives a satellite signal from a GNSS satellite as a snapshot, first measurement data at a first time and second measurement data at a second time in each of which the number of acquired satellites is less than five and in which the total number of acquired satellites is greater than or equal to five;
combining the first measurement data and the second measurement data together using a time difference between the first time and the second time such that the number of acquired satellites is greater than or equal to five; and
computing a position of the sensor terminal.
